(19) United States
(12) Patent Application Publication
(10) Pub. No.: US 2012/0061508 A1
(43) Pub. Date: Mar. 15, 2012

(54) DEVICE FOR FIRING WEAPONS FROM AN ARMED DRONE

(75) Inventors: Gregoire de Viry, Leognan (FR); Guillaume Dupont, Pessac (FR)

(73) Assignee: Thales, Neuilly Sur Seine (FR)

(21) Appl. No.: 12/639,735

(22) Filed: Dec. 16, 2009

(30) Foreign Application Priority Data
Dec. 19, 2008 (FR) 0807212

(51) Int. Cl. F41G 7/26; F41G 5/18

(52) U.S. Cl. 244/3.16; 89/41.21

(57) ABSTRACT

The present invention relates to the field of unmanned air vehicles, more commonly designated drone. More specifically, the invention applies to an armed drone system (10), notably equipped with a firing device and a steerable optronics ball (B) comprising means of illuminating targets (C).

The invention proposes that the firing device be oriented towards the rear, so as to reduce the problems of masking of the optronics ball (B) by elements located in its line of sight, such as a front wheel (FW) for example. Moreover, because of operational use involving a phase (10S) for firing weapons and illuminating the target (C) from the back, the armed drone (10) moving away from the target, the vulnerability of the drone (10) is lessened.

### CROSS REFERENCE TO RELATED APPLICATIONS

The present application claims priority to French Patent Application Ser. No. 08 07212, filed Dec. 19, 2008, which is hereby incorporated by reference in its entirety.

### TECHNICAL FIELD

The present invention relates to the field of unmanned air vehicles, more commonly designated as drones. More specifically, the invention applies to an armed drone system, or combat drone.

These drones are often designated by the English acronym UCAV (for Unmanned Combat Air Vehicle).

### BACKGROUND OF THE INVENTION

Currently, a firing device fitted on an armed drone is generally provided with weapons, missiles or rockets, that are guided. This means that said weapons are capable of reaching with accuracy a target provided that the latter is designated or “illuminated” by appropriate means, such as a laser, that is available to the armed drone.

Also, in the state of the art, an armed drone comprises, in addition to the firing device proper, a steerable optronics ball, comprising at least one camera, typically capable of rotations ranging from 0° to 360° in azimuth and from +10° to −180° in elevation relative to the horizontal plane including said optronics ball; such an optronics ball is intended rather for observing to the side of the drone. This optronics ball also makes it possible to acquire at least one target intended to be targeted by the firing device. Hereinafter in the description and in the claims, the acquisition of a target refers to the sighting and identification as a target of an element located in the environment of the armed drone, generally on the ground. The terms “designating” or “illuminating” a target refer to a marking of the target by the use of appropriate means conventionally associated with the optronics ball, for example a laser, so as to enable a weapon to be guided towards said target.

Now, when the optronics ball points straight in front, elements of the drone, such as a front wheel, or an antenna, generally create a masking problem. This type of problem affects all the drones, in particular the drones with fixed wings, that include in practice a front wheel, said front wheel most often not being retractable. A masking can also be produced by the presence of an antenna under the nose of the drone. Now, the optronics ball generally comprises, for an armed drone, the means of illuminating targets. Moreover, the current armed drones all present the characteristic of performing their firings towards the front, according to a flight tactic called “towards the objective”. Consequently, the masking problem described previously can make an armed drone fire without the target being illuminated and without visibility. Now, firing without illumination and without visibility is almost impossible, notably because it is incompatible with the current firing doctrines. In practice, in addition to the obvious lack of accuracy, that can cause collateral damage, this firing mode does not allow the firing sequence to be stopped in the event of the interference of neutral elements in the firing range.

To resolve this problem, a first solution consists in reducing the range of the firing according to the masking problem and another in strongly inclining the firing device downward; however, this diminishes the intrinsic possibilities of the armed drone. Moreover, original firing modes have been developed. For example, it is possible to carry out an avoidance manoeuvre after the firing in order to re-acquire the target. The latter possibility is nevertheless difficult to implement and induces a negative impact on the aerodynamic performance of the drone.

Furthermore, another problem associated with the “flight towards the objective” tactic has no solution in the current armed drone systems. This is the vulnerability of said armed drones, moving forward at low speed towards the objective, and continuing to approach thereto in the firing phase and after firing. This second drawback is not resolved in the state of the art.

One aim of the invention is notably to overcome the above-mentioned drawbacks. Thus, to overcome problems of masking of the target illumination means and reducing the vulnerability of an armed drone in the firing phase, the invention proposes an armed drone equipped with a rear-oriented firing device.

### SUMMARY OF THE INVENTION

In this context, the subject of the invention is an unmanned air vehicle, comprising fixed or rotating wings, a device for firing guided weapons, and a steerable optronics ball fixed below said unmanned air vehicle, and intended to acquire at least one target, said guided weapons firing device being oriented backwards, presenting a firing axis forming, in azimuth, an angle substantially equal to 180° relative to the direction of movement of the unmanned air vehicle.

Preferably, the guided weapons are rockets or missiles.

In an exemplary implementation of the invention, the unmanned air vehicle comprises fixed wings, and wheels intended to allow said unmanned air vehicle to land, one of the wheels being located in the line of sight of the optronics ball when said optronics ball points straight in front relative to the direction of movement of the unmanned air vehicle.

Advantageously, the air vehicle also comprises means of illuminating the target, making it possible to guide, a guided weapon fired by said firing device towards the target.

Advantageously, a method of firing at least one guided weapon towards a target from an unmanned air vehicle can comprise a step for firing a guided weapon backwards, the firing being performed from the unmanned air vehicle according to the invention.

Advantageously, the method according to the invention comprises the following steps:
acquisition of the target by the optronics ball, regardless of the angle formed by the direction targeted by the optronics ball handling the acquisition of the target and the direction of movement of the unmanned air vehicle,
guidance of the unmanned air vehicle so that the target is located towards the rear of the unmanned air vehicle, that is to say, so that the target is located in a direction forming, in azimuth, an angle of between 90° and 270° relative to the direction of movement of the unmanned air vehicle,
illumination and firing of the guided weapon towards the target located to the rear, while the unmanned air vehicle is moving away from said target.

Advantageously, the method according to the invention can also comprise a step for checking the damages caused.

In the method according to the invention, the guidance of the unmanned air vehicle is preferentially handled so that the target is located in a direction forming, in azimuth, an angle of approximately 180° relative to the direction of movement of said unmanned air vehicle.

### BRIEF DESCRIPTION OF THE DRAWINGS

Other characteristics and advantages of the invention will become apparent from the following description, given in light of the appended drawings which represent:

FIG. 1: a diagrammatic overall view of an exemplary armed drone according to the state of the art;

FIGS. 2a and 2b: diagrammatic views of the areas masked by a front wheel in an exemplary fixed-wing armed drone;

FIG. 3: the diagrammatic representation of areas of vulnerability of a current armed drone in the context of operational use;

FIGS. 4a and 4b: diagrammatic views of the residual masking areas in the context of use of the device according to the invention;

FIG. 5: the representation of the sequence comprising the acquisition, illumination of a target and firing of a weapon, and the checking of the damages caused in the context of implementation of the device according to the invention.

### DETAILED DESCRIPTION OF THE INVENTION

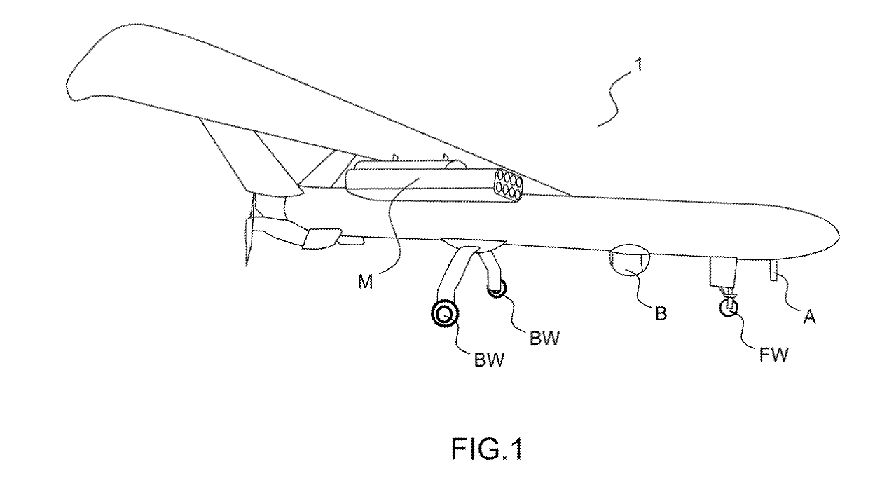

FIG. 1 shows a diagram of an exemplary armed drone 1 in a conventional configuration. The latter is a fixed-wing drone, and has two rear wheels BW and a front wheel FW. It also comprises an antenna A, fixed underneath the drone 1, and a steerable optronics ball B such as that described hereinabove, intended for the observation and acquisition of targets. The armed drone 1 moreover comprises a firing device M, capable of firing guided weapons, of missile or rocket type. The optronics ball B includes or cooperates with means of illuminating the target or targets acquired, so as to allow the guided weapon or weapons fired towards the target or targets to be guided. The armed drone 1 also has at least one antenna A, allowing communication with operators located on the ground, and generally fixed under the nose of the drone.

As in the diagram of FIG. 1, the firing devices M fitted on the current armed drones are always oriented towards the front, making it possible to fire only towards the front.

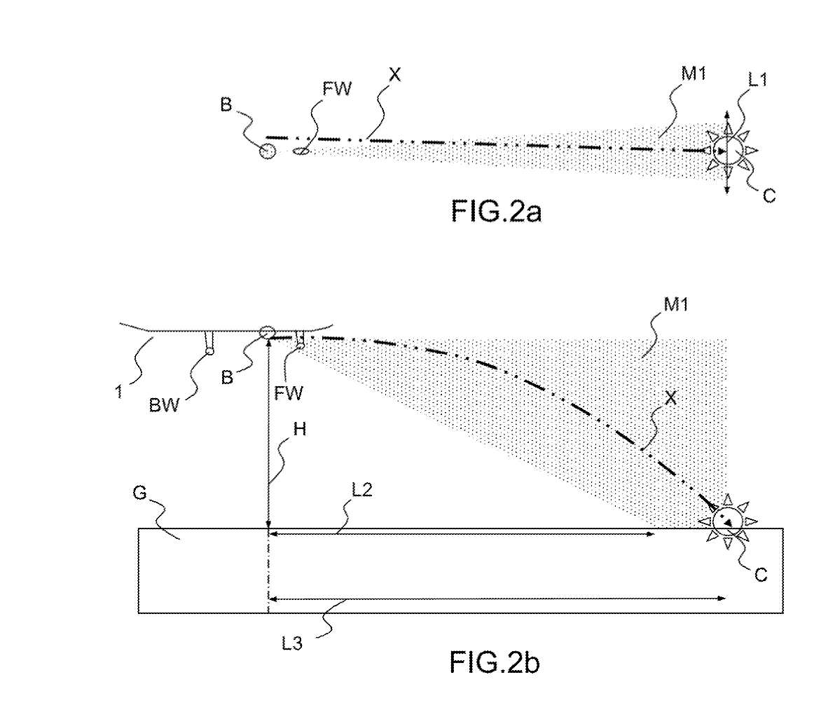

FIGS. 2a and 2b illustrate the masking problems resulting from this orientation towards the front of the firing device M, which evolves from a “flight towards the objective” firing strategy. In effect, the current armed drones 1, such as that represented in FIG. 1, conventionally include, as has been seen, a front wheel FW and at least one antenna A, which are located in the field of the optronics ball B when the latter points straight in front of the armed drone 1. Now, the armed drones 1 of the state of the art include a firing device M that is oriented towards the front, and therefore a firing axis X that is also located towards the front of the armed drone 1, in the same direction as its direction of movement.

Thus, taking the example of an armed drone such as that represented in FIG. 1, the area M1 that is masked to the optronics ball B and therefore to the illumination means by the front wheel FW of the armed drone 1 corresponds to the space M1 represented through the plan view of FIG. 2a, and the profile view of FIG. 2b. For a standard front wheel FW, approximately 10 centimetres wide and approximately 60 centimetres high, this space M1 typically presents, according to FIG. 2a, a width of approximately 600 metres, at 5000 metres in front of the drone 1. FIG. 2b, showing a target C on the ground, the drone 1 moving at a ground height H of approximately 1000 metres, makes it possible to evaluate the masked area M1 as affecting any element situated on the ground at more than 4000 metres from the drone I in distance, within the limit defined in FIG. 2a. Showing FIGS. 2a and 2b in perspective makes it possible to comprehend the size of the volume within which a target would be masked to the optronics ball B and therefore to the illumination means of the armed drone 1. Consequently, the presence of a target C in the area M1 implies the absence of the possibility of direct illumination of said target C. This leads either to the absence of firing, or to firing without visibility, or a complex avoidance and re-acquisition manoeuvre just after the firing.

This drawback, as will be seen a little later, is more than corrected thanks to the device according to the invention.

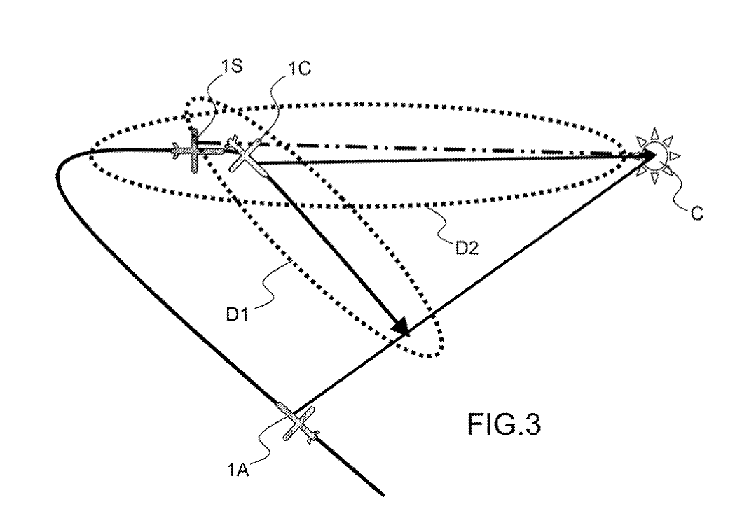

FIG. 3 diagrammatically represents a phase of approach towards and illumination of a target C and of firing of a guided weapon by an armed drone 1 of the state of the art. During this sequence, the armed drone 1 is particularly vulnerable, notably in the areas D1 and D2. In practice, because of the “flight towards the objective” firing tactic, the only possible tactic because of the orientation towards the front of the firing device M, the armed drone, in the firing and illumination phase 1S, after acquisition, in phase 1A, of a target C, illuminates the target C if it is visible and fires a guided weapon. The armed drone, in phase 1C, then continues to approach id the target C during the phase for the checking damages caused thanks to the optronics ball B. During the phase 1S of illumination and firing and during the phase 1C for checking the damages caused, the armed drone is extremely vulnerable: these areas of great vulnerability correspond to the areas D1 and D2 in FIG. 3.

Should the target C be masked at the moment of the firing phase 1S, obliging the armed drone to make an avoidance manoeuvre just after the firing, the phase 1S would include, after the firing of the weapon, a phase for re-acquisition of the target C followed by its illumination. This in no way changes the vulnerability of the drone during this sequence, because the drone continues to approach the target C during the critical illumination, firing and damage-checking phases, all of which is also at very low speed.

This second defect in the armed drones of the state of the art will also be resolved in the device according to the invention.

Thus, the device according to the invention consists of a firing device for an armed drone, characterized in that it is oriented towards the rear. The invention lies also in an armed drone as such, comprising a firing device oriented towards the rear. The invention also relates to a method of firing at least one guided weapon towards at least one target, implementing a firing device that is oriented towards the rear.

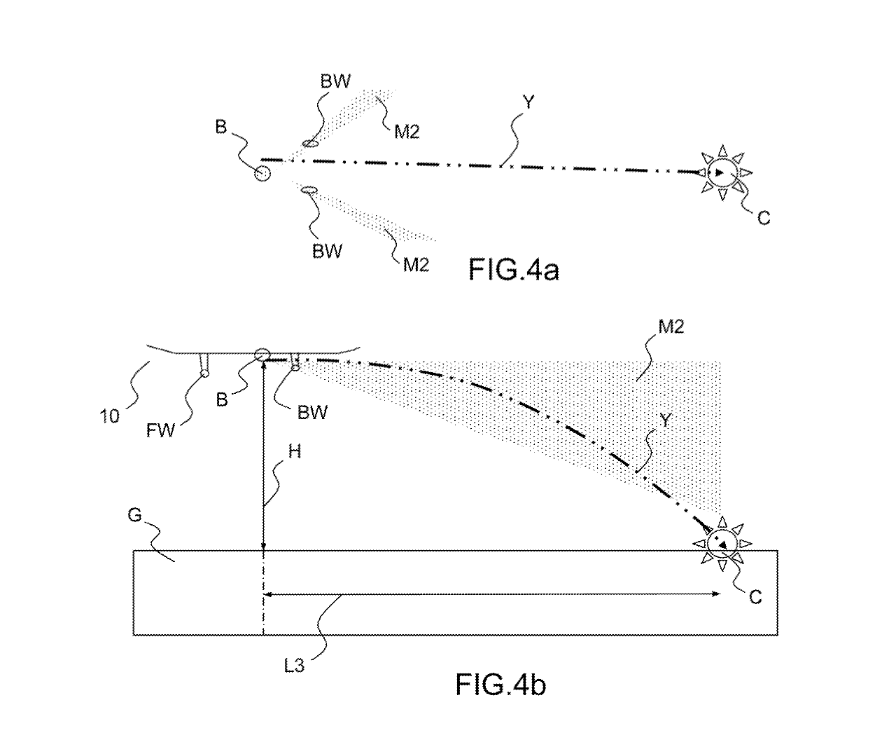

In this context, FIGS. 4a and 4b represent the residual masked areas that can affect an exemplary armed drone 10 including a firing device that is oriented towards the rear. Such an armed drone 10 comprises a steerable optronics ball B of the state of the art. In a context equivalent to that of FIGS. 2a and 2b, that is to say with a drone 10 located at a ground height H of approximately 1000 metres and with a target to be dealt with located approximately 5000 metres away from the drone 10. The armed drone 10 has, according to the invention, a firing axis Y located towards the rear. Thus, the masking areas M2, due to the rear wheels BW with which a fixed-wing drone of the type of that of FIG. 1 is provided, do not interfere with the line of sight of the optronics ball B pointing straight behind the drone 10, as shown in FIG. 4a. Similarly, the masked area M2 appearing in FIG. 4b is not located in the line of sight of the optronics ball B pointing straight behind. Furthermore, since the firing device is oriented towards the rear, the firing of a guided weapon and the illumination of the target C are done while the drone 10 is moving away from said target C. A target C is therefore dealt with according to a flight tactic called “fire and escape”, which consists by definition in moving away from the target C during the firing and illumination phase.

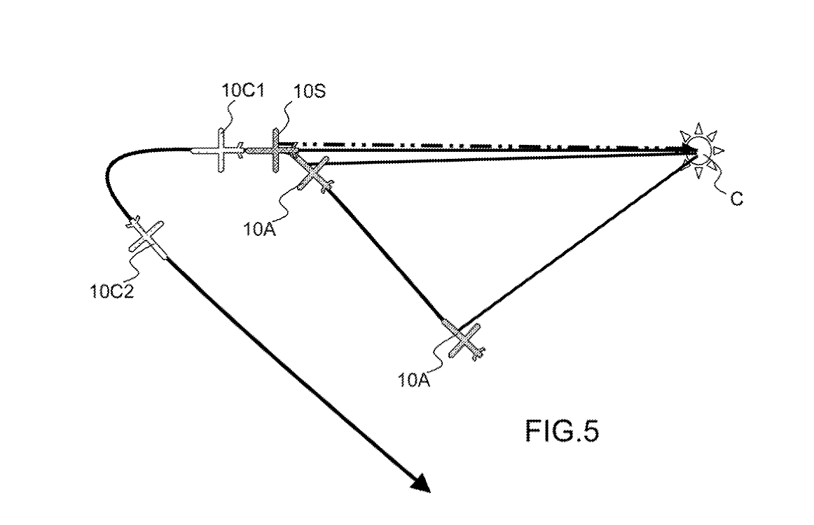

From this flight tactic made possible by the fact of firing towards the rear there devolves a lesser vulnerability of the armed drone 10. In practice, FIG. 5 shows a sequence comprising the acquisition, in a phase 10A, of a target C, followed by the firing of a guided weapon and the illumination of said target C, in phase 10S, towards the rear of the drone that is moving away from the target C in phase 10C1. According to the invention, the armed drone can then carry out a check on the damages caused in a phase 10C2. Thus, once the target C has been acquired, the armed drone according to the invention moves away from the target C targeted throughout the firing and illumination phase 10S. Its presence at low speed close to the target C is therefore reduced.

To sum up, the invention offers the advantage of proposing a simple solution aiming to resolve two major problems associated with the use of unmanned air vehicles provided with a firing device. By proposing a device for firing towards the rear, the invention makes it possible in practice to reduce the problems of masking of the optronics ball by elements located in its line of sight, such as a front wheel for example, and, because of an operational use involving a firing of weapons and an illumination of the target from the rear of the armed drone, said armed drone moving away from the targeted target from the firing and illumination phase, to significantly reduce the vulnerability of the drone.

1-8. (canceled)

9. Unmanned air vehicle, comprising fixed or rotating wings, a device for firing guided weapons, and a steerable optronics ball fixed below said unmanned air vehicle, and intended to acquire at least one target, wherein said guided weapons firing device is oriented backwards, presenting a firing axis forming, in azimuth, an angle substantially equal to 180° relative to the direction of movement of the unmanned air vehicle.

10. Unmanned air vehicle according to claim 9, wherein said guided weapons are rockets or missiles.

11. Unmanned air vehicle according to claim 9, comprising fixed wings, and wheels intended to allow said unmanned air vehicle to land, one of the wheels being located in the line of sight of the optronics ball when said optronics ball points straight in front relative to the direction of movement of the unmanned air vehicle.

12. Unmanned air vehicle according to claim 9, comprising means of illuminating the target, making it possible to guide a guided weapon fired by said firing device towards the target.

13. Unmanned air vehicle according to claim 11, comprising means of illuminating the target, making it possible to guide a guided weapon fired by said firing device towards the target.

14. Method of firing at least one guided weapon towards a target from an unmanned air vehicle, comprising a step for firing a guided weapon backwards, the firing being performed from the unmanned air vehicle according to claim 9.

15. Method according to claim 14, comprising the following steps:
acquisition of the target by the optronics ball, regardless of the angle formed by the direction targeted by the optronics ball handling the acquisition of the target and the direction of movement of the unmanned air vehicle,
guidance of the unmanned air vehicle so that the target is located towards the rear of the unmanned air vehicle, that is to say, so that the target is located in a direction forming, in azimuth, an angle of between 90° and 270° relative to the direction of movement of the unmanned air vehicle,
illumination and firing of the guided weapon towards the target located to the rear, while the unmanned air vehicle is moving away from said target.

16. Method according to claim 15, comprising a step for checking the damages caused.

17. Method according to claim 15, wherein the guidance of the unmanned air vehicle is handled so that the target is located in a direction forming, in azimuth, an angle of approximately 180° relative to the direction of movement of said unmanned air vehicle.

18. Method according to claim 16, wherein the guidance of the unmanned air vehicle is handled so that the target is located in a direction forming, in azimuth, an angle of approximately 180° relative to the direction of movement of said unmanned air vehicle.
